(19) United States
(12) Patent Application Publication
(10) Pub. No.: US 2024/0193628 A1
(43) Pub. Date: Jun. 13, 2024

(54) METHOD AND SYSTEM FOR FEATURE EXTRACTION AND DATA PREDICTION BASED ON PRE-TRAINING

(71) Applicant: DUN-QIAN Intelligent Technology Co., Ltd., Taichung City (TW)

(72) Inventors: Yen-Chu Chen, Chiayi City (TW); Ling-Jung Lin, Tainan City (TW); Shao-Chen Liu, Taichung City (TW); Hsuan-Wei Chen, Taichung City (TW); Shuh-Shian Tsai, New Taipei City (TW)

(73) Assignee: DUN-QIAN Intelligent Technology Co., Ltd., Taichung City (TW)

(21) Appl. No.: 18/088,803

(22) Filed: Dec. 27, 2022

(30) Foreign Application Priority Data
Dec. 9, 2022 (TW) 111147352

(51) Int. Cl. G06Q 30/0202; G06Q 30/0201

(52) U.S. Cl. CPC G06Q 30/0202; G06Q 30/0206

(57) ABSTRACT

A method for feature extraction and data prediction based on pre-training, includes building a first neural network, inputting first processed data to the first neural network to perform a first training operation to generate a first trained neural network, inputting second processed data to the first trained neural network and fixing a first portion of neurons of the first trained neural network to perform a second training operation to generate a second trained neural network, and inputting third processed data to the second trained neural network to generate a predicted result. A first portion of neurons of the second trained neural network is the same as the first portion of neurons of the first trained neural network.

### BACKGROUND OF THE INVENTION

### 1. Field of the Invention

The disclosure is related to a method and a system for feature extraction and data prediction based on pre-training, and more particularly, a method and a system for feature extraction and data prediction based on pre-training where a first portion of neurons of a trained neural network can be applied repeatedly.

### 2. Description of the Prior Art

Regarding marketing, it is a challenge to predict future operating indicators, such as sales amount. At present, users can make predictions according to personal instinct and the sales records of comparable periods in the past. However, in this way, personal instinct may not be reliable, and the considered parameters are also highly limited.

With the development of machine learning technology, it may be allowable to estimate future operating indicators based on machine learning. However, when machine learning is performed, a neural network should be trained, and a great number of training operations often require considerable hardware and software resources. Hence, a suitable solution is still in need to improve the efficiency of machine learning, shorten training time, and reduce cost of hardware and software.

### SUMMARY OF THE INVENTION

An embodiment provides a method for feature extraction and data prediction based on pre-training. The method includes converting first data to generate first processed data with a predetermined format, building a first neural network, inputting the first processed data to the first neural network to perform a first training operation to generate a first trained neural network, converting second data to generate second processed data with the predetermined format, inputting the second processed data into the first trained neural network and fixing a first portion of neurons of the first trained neural network to perform a second training operation to generate a second trained neural network, and inputting third processed data with the predetermined format to the second trained neural network to generate a predicted result. A first portion of neurons of the second trained neural network is the same as the first portion of neurons of the first trained neural network.

Another embodiment provides a system for feature extraction and data prediction based on pre-training. The system includes a data unit, a data process unit and a feature extraction and data prediction unit. The data unit is used to provide first data, second data and third data. The data process unit is used to process the first data, the second data and the third data to generate first processed data, second processed data and third processed data each having a predetermined format. The feature extraction and data prediction unit is used to build a first neural network, input the first processed data to the first neural network to perform a first training operation to generate a first trained neural network, input the second processed data to the first trained neural network and fixing a first portion of neurons of the first trained neural network to perform a second training operation to generate a second trained neural network, and input third processed data into the second trained neural network to generate a predicted result. A first portion of neurons of the second trained neural network is the same as the first portion of neurons of the first trained neural network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a system for feature extraction and data prediction based on pre-training according to an embodiment.

FIG. 2 illustrates a method for feature extraction and data prediction based on pre-training according to the embodiment of FIG. 1.

FIG. 3 illustrates a first neural network trained to generate a first trained neural network according to an embodiment.

FIG. 4 illustrates the first trained neural network trained to generate a second trained neural network.

FIG. 5 illustrates the second trained neural network used to generate the predicted result.

### DETAILED DESCRIPTION

Hereinafter, when “and/or” is used to connect a plurality of items, the description means at least one of the items and any combinations of the items. For example, “A and/or B” can mean at least one of “A”, “B” and “A and B”.

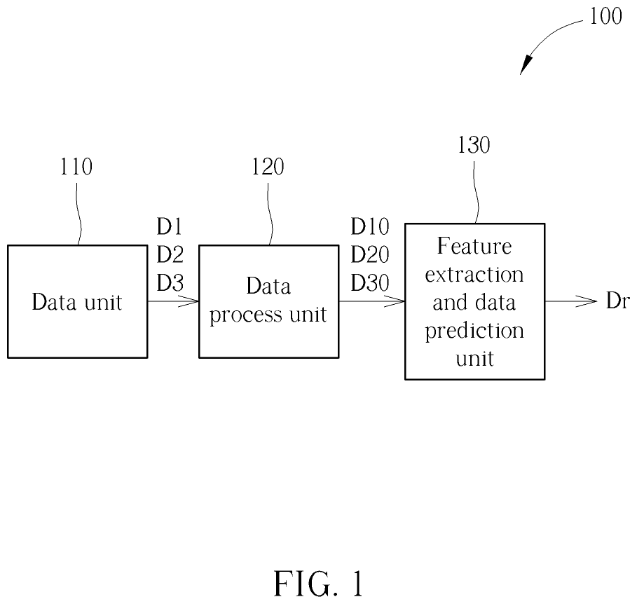

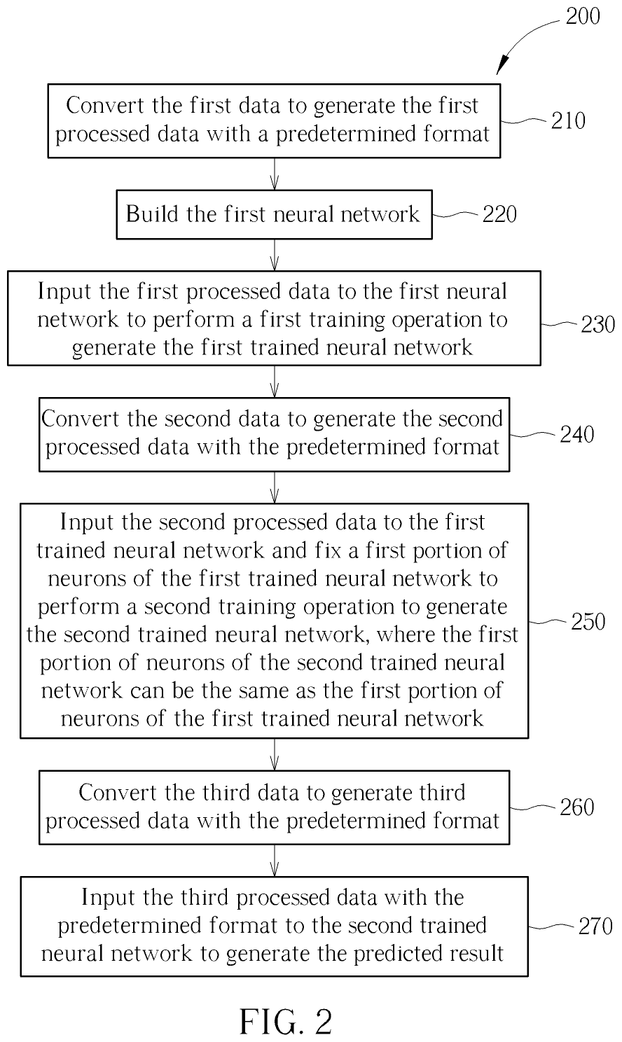

FIG. 1 illustrates a system 100 for feature extraction and data prediction based on pre-training according to an embodiment. FIG. 2 illustrates a method 200 for feature extraction and data prediction based on pre-training according to the embodiment of FIG. 1.

The system 100 can include a data unit 110, a data process unit 120 and a feature extraction and data prediction unit 130. The data unit 110 can provide first data D1, second data D2 and third data D3. For example, the first data D1 can include historical data of a first hotel used for training operations of machine learning. The second data D2 can include historical data of a second hotel used for training operations of machine learning. The third data D3 can include to-be-evaluated data of the second hotel used for predicting future operating indicators. Each of the first data D1, the second data D2 and the third data D3 can include hardware features, sales records (e.g. room rates and sales amounts), weather data, press releases, room rates of competitors collected from online agencies (OTAs) and/or economic data. The data unit 110 can include memory devices such as non-volatile memories disposed in a remote cloud memory device and/or a local memory device.

The data process unit 120 can process the first data D1, the second data D2 and the third data D3 to generate first processed data D10, second processed data D20 and third processed data D30 each having a predetermined format. The data process unit 120 can normalize and/or standardize the first data D1, the second data D2 and the third data D3 to generate the first processed data D10, the second processed data D20 and the third processed data D30 with the same predetermined format.

The feature extraction and data prediction unit 130 can perform feature extraction and machine learning to generate a predicted result Dr. The predicted result Dr can include future operating indicators, such as room rates and sales amounts. The operations performed by feature extraction and data prediction unit 130 can be as described in FIG. 2 to FIG. 5.

Each of the data process unit 120 and the feature extraction and data prediction unit 130 can have computation ability and be implemented using hardware device(s), such as a central processing unit (CPU), a controller, a tensor processing unit (TPU) and/or a graphic processing unit (GPU).

If the system 100 is used for hotel operations, the predicted result Dr can include a plurality of room rates and a plurality of dates corresponding to the plurality of room rates, and/or a plurality of room nights and a plurality of dates corresponding to the plurality of room nights. “Room night” can be the unit of the sales of hotel rooms. When N rooms are booked for M days, the number of room nights can be the product of N and M (i.e. N×M). For example, when one room is booked for one day, the number of room nights can be 1. When one room is booked for two days, the number of room nights can be 2. When two rooms are booked for one day, the number of room nights can also be 2.

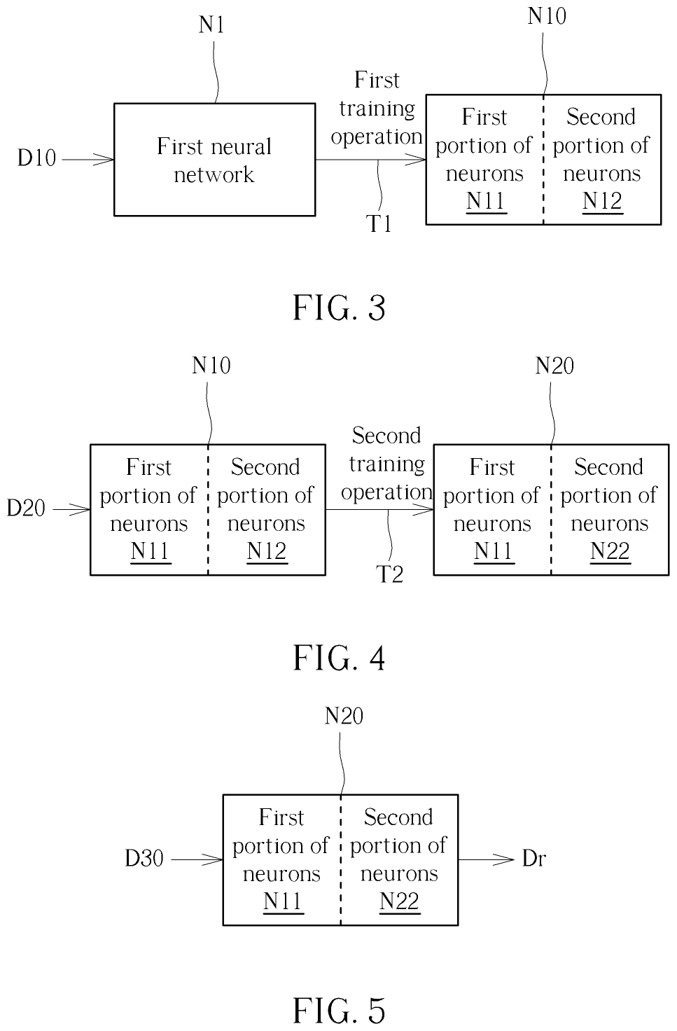

FIG. 3 illustrates a first neural network N1 trained to generate a first trained neural network N10 according to an embodiment. FIG. 4 illustrates the first trained neural network N10 trained to generate a second trained neural network N20. FIG. 5 illustrates the second trained neural network N20 used to generate the predicted result Dr. As shown in FIG. 1 to FIG. 5, the method 200 in FIG. 2 can include the following steps.

Step 210: convert the first data D1 to generate the first processed data D10 with a predetermined format;

Step 220: build the first neural network N1;

Step 230: input the first processed data D10 to the first neural network N1 to perform a first training operation T1 to generate the first trained neural network N10;

Step 240: convert the second data D2 to generate the second processed data D20 with the predetermined format;

Step 250: input the second processed data D20 to the first trained neural network N10 and fix a first portion of neurons N11 of the first trained neural network N10 to perform a second training operation T2 to generate the second trained neural network N20, where the first portion of neurons N11 of the second trained neural network N20 can be the same as the first portion of neurons N11 of the first trained neural network N10;

Step 260: convert the third data D3 to generate third processed data D30 with the predetermined format; and

Step 270: input the third processed data D30 with the predetermined format to the second trained neural network N20 to generate the predicted result Dr.

Steps 210, 240 and 260 can be performed using the data unit 110 and the data process unit 120 in FIG. 1. Steps 220, 230, 250 and 270 can be performed using the feature extraction and data prediction unit 130 in FIG. 1.

As shown in FIG. 3 to FIG. 5, the first trained neural network N10 can include the first portion of neurons N11 and a second portion of neurons N12. The second trained neural network N20 can include the first portion of neurons N11 and a second portion of neurons N22. The first portion of neurons N11 of the second trained neural network N20 can be the same as the first portion of neurons N11 of the first trained neural network N10. In the text, a first portion of neurons can be a former portion of neurons in a neural network, and a second portion of neurons can be a latter portion of neurons in the neural network.

In Steps 210, 240 and 260, by converting data into processed data with a predetermined format, the contribution of each feature of the data to machine learning can be adjusted to improve accuracy. In Step 220, the first neural network N1 can include a convolutional neural network (CNN) model and a long short term memory (LSTM) model. Each of the first trained neural network N10 and the second trained neural network N20 can include a convolutional neural network model and a long short term memory model.

In Step 230, the first training operation T1 can include using the first portion of neurons N11 of the first trained neural network N10 to perform feature extraction to learn a relationship between two features and learn changes of features over time. For example, the features can be related to hardware feature, sales records (e.g. room rates and sales amounts), weather data, press releases, room rates of competitors gathered from online agencies (OTAs) and/or economic data. The first training operation T1 can make the first portion of neurons N11 of the first trained neural network N10 to learn the effect caused by a feature upon other features, and the changes of a plurality of features over time. For example, if a room rate falls after three times of rate increase, the first portion of neurons N11 can learn the changes. In another example, the first processed data D10 can include at least one date, a feature and a time window. Hence, the first processed data D10 can be three dimensional data. Taking hotel room rate as an example, when generating the first processed data D10, a data table of hotel room rates and dates can be formed, and a time window (e.g. with a length of seven days) can be shifted on the table. Hence, the first processed data D10 with a three dimensional format can be generated according to the hotel room rates and the dates corresponding to each position of the time window on the data table. In this way, the relationships among features and the predicted result Dr can be considered with taking factors of time into account.

The first trained neural network N10 can predict the operating indicators of the first hotel according to the historical data of the first hotel. In the first trained neural network N10, the first portion of neurons N11 can perform feature extraction, and the second portion of neurons N12 can perform data prediction.

In Step 250, the first portion of neurons N11 of the first trained neural network N10 can be fixed and “frozen”. The second processed data D20 can be inputted to the first trained neural network N10 to perform the second training operation T2 to generate the second trained neural network N20. In other words, the second training operation T2 can be performed to train the second portion of neurons N12 to generate the second portion of neurons N22. The second portion of neurons N12 can be replaced with the second portion of neurons N22 so as to generate the second trained neural network N20. The second trained neural network N20 can include the first portion of neurons N11 and the second portion of neurons N22.

The second trained neural network N20 can receive the to-be-evaluated data of the second hotel to predict the future operating indicators of the second hotel, as mentioned in Step 270.

In the second trained neural network N20, the first portion of neurons N11 can perform feature extraction, and the second portion of neurons N22 can perform data prediction. Since in the second trained neural network N20, the first portion of neurons N11 of the first trained neural network N10 can be repeatedly used, the training time and the required resources of hardware and software for machine learning are effectively reduced.

Each of the second portion of neurons N12 of the first trained neural network N10 and the second portion of neurons N22 of the second trained neural network N20 can include a fully-connected layer of neurons and be used to predict operating indicators of a hotel.

Each of the first training operation T1 and the second training operation T2 can form a decision tree. Through forming decision trees, first trained neural network N10 and the second trained neural network N20 can perform prediction according to known data. Classification and regression tree (CART) algorithm and/or random forest algorithm can be used to form a decision tree.

Regarding the second portion of neurons N12 and N22, the time series prediction model in use can include a long short term memory (LSTM) model and/or a recurrent neural network (RNN) model.

In the following, the sales of hotel rooms are taken as an example. Historical sales data of a plurality of hotels can be converted to have the same format. Since the dates of the sales data of different hotels may be different, the data can be standardized, and then the features of the hotels can be filled into the data. The features may be generated according to hotel hardware, scenic spot labels, weather data, room rates of competitors, press releases of the locations of the hotels, etc. A data set including the processed historical hotel data can be inputted to the neural network according to a sequence of the hotels so as to perform training operations.

In Step 220, the neural network such as a combination of a convolutional neural network (CNN) model and a long short term memory (LSTM) model can be built, and embodiments are not limited thereto. Through the feature selection performed with the convolutional neural network, a pre-trained model can be built. The important features selected by the convolutional neural network can be reused when processing other similar data. In addition, the features selected by the convolutional neural network can be used as the input of the long short term memory model.

In addition to the abovementioned combination of a convolutional neural network (used for feature extraction) and a long short term memory model, other combinations of models can be used to form a pre-trained model. For example, a decision tree with a time series prediction model can be used. Taking the random forest algorithm in the decision tree algorithms as an example, the data can be inputted to the random forest to calculate important features, and then a threshold can be used for selecting a set of the important features, and the selected important features can be inputted to a long short term memory model for pre-training.

A plurality of algorithms related to decision tree can be used. For example, a random forest algorithm and/or a classification and regression tree (CART) algorithm can be used. A time series prediction model can include a long short term memory model and/or a recurrent neural network model. The trained model can be formed with at least one of the different combinations of the abovementioned models.

After Step 230 of FIG. 2 is performed, the first portion of neurons N11 can be saved, and the neurons except the output layer (e.g. the output layer can be the second portion of neurons N12) can be modeled separately to form a pre-trained model. When a prediction model is needed to perform predictions for a new hotel, the data of the new hotel can be inputted to the pre-trained model for retraining and feature extraction, and a predetermined algorithm or other prediction models can be used to generate a predicted result (e.g. the predicted result Dr in FIG. 5).

The trained data and parameters of known hotels in the fixed neurons (e.g. N11) can be used for a new hotel with insufficient data, and a neural network model for the new hotel can be generated accordingly. Each of the first data D1, the second data D2 and the third data D3 in FIG. 1 can include time series data. When performing pre-training, in addition to the relationships among features and the predicted result Dr, the effects caused by the features over time are also taken into account.

Data of each hotel can be normalized and standardized to form a data set. The sales data with time-series features can be processed by shifting a time window (e.g. seven days) to adjust two dimensional data related to dates and features to generate three dimensional data of dates, features and time windows. A piece of data can include sales data and related features in a period of seven days. Below, an example is provided, where a neural network of a combination of a recurrent neural network and a long short term memory model is used. After the neural network (e.g. N1 in FIG. 3) is initialized, the recurrent neural network can perform feature selection and feature extraction to find out the relationships among features and the predicted result Dr. The long short term memory model can perform learning with time-series data to learn the causal relationships among the features and the predicted result Dr in time. In addition, the fully-connected layer (e.g. N12 in FIG. 3 and FIG. 4) stacked at the end layer of the neural network can perform regression prediction, and the results can be added into a large data set to perform supervised training. The generated prediction model can be used to predict operating indicators of hotels related to the data set, and the operating indicators can include predicted room rates and predicted booked room nights in the predicted result Dr. When a new hotel (e.g. the abovementioned second hotel) is to be evaluated, parameters of a first portion of neurons (e.g. N11 in FIG. 3 and FIG. 4) of the neural network can be fixed, parameters of a second portion of neurons (e.g. N12 in FIG. 3 and FIG. 4) of the neural network can be initialized, and data of the new hotel can be inputted to the neural network to perform re-training. In this way, the feature processing and logic for data conversion can be reused to generate a prediction model (e.g. N20 in FIG. 4 and FIG. 5) for the new hotel.

In summary, through the method and system provided by embodiments, the first portion of neurons of the neural network can be repeatedly used, so the training time and resources of hardware and software are effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for feature extraction and data prediction based on pre-training, comprising:
converting first data to generate first processed data with a predetermined format;
building a first neural network;
inputting the first processed data to the first neural network to perform a first training operation to generate a first trained neural network;
converting second data to generate second processed data with the predetermined format;
inputting the second processed data to the first trained neural network and fixing a first portion of neurons of the first trained neural network to perform a second training operation to generate a second trained neural network; and
inputting third processed data with the predetermined format to the second trained neural network to generate a predicted result;
wherein a first portion of neurons of the second trained neural network is the same as the first portion of neurons of the first trained neural network.

2. The method of claim 1, wherein the first data is normalized and/or standardized to generate the first processed data, and the second data is normalized and/or standardized to generate the second processed data.

3. The method of claim 1, wherein the first neural network comprises a convolutional neural network (CNN) model and a long short term memory (LSTM) model.

4. The method of claim 1, wherein each of the first training operation and the second training operation comprises forming a decision tree.

5. The method of claim 1, wherein:
the first data comprises historical data of a first hotel;
the second data comprises historical data of a second hotel;
third data comprises to-be-evaluated data of the second hotel; and
the method further comprises converting the third data to generate the third processed data.

6. The method of claim 1, wherein the predicted result comprises:
a plurality of rates, and a plurality of dates corresponding to the plurality of rates; and/or
a plurality of room nights, and a plurality of dates corresponding to the plurality of room nights.

7. The method of claim 1, wherein the first training operation comprises using the first portion of neurons of the first trained neural network to perform feature extraction to learn a relationship between two features and learn changes of a feature over time.

8. The method of claim 1, wherein the first processed data comprises at least one date, a feature and a time window.

9. The method of claim 1, wherein a second portion of neurons of each of the first trained neural network and the second trained neural network comprises a fully-connected layer of neurons configured to perform a prediction operation.

10. A system for feature extraction and data prediction based on pre-training, comprising:
a data unit configured to provide first data, second data and third data;
a data process unit configured to process the first data, the second data and the third data to generate first processed data, second processed data and third processed data each having a predetermined format; and
a feature extraction and data prediction unit, configured to build a first neural network, input the first processed data to the first neural network to perform a first training operation to generate a first trained neural network, input the second processed data to the first trained neural network and fixing a first portion of neurons of the first trained neural network to perform a second training operation to generate a second trained neural network, and input third processed data into the second trained neural network to generate a predicted result;
wherein a first portion of neurons of the second trained neural network is the same as the first portion of neurons of the first trained neural network.
